(19) United States
(12) Patent Application Publication
(10) Pub. No.: US 2009/0245277 A1
(43) Pub. Date: Oct. 1, 2009

(54) Information Receiver and Method for Receiving Information

(75) Inventors: Hiroshi Kawada, Tachikawa-shi (JP); Noriya Sakamoto, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/364,297

(22) Filed: Feb. 2, 2009

(30) Foreign Application Priority Data
Mar. 28, 2008 (JP) 2008-086899

(51) Int. Cl. H04J 3/22

(52) U.S. Cl. 370/466

(57) ABSTRACT

An information receiver includes: a communication module that is configured to receive, over a network, information from a first apparatus that uses an internet protocol of a first version as a communication protocol and a second apparatus that uses an internet protocol of a second version as a communication protocol; and a storage module that stores names of the first apparatus and the second apparatus from which the communication module has received information, each of the names being correlated with the internet protocol of one of the first version and the second version being used when the respective names are received, wherein the communication module receives information from the first apparatus or the second apparatus using the internet protocol of the first version or second version by referring to the names and the internet protocol being correlated therewith stored in the storage module.

### CROSS REFERENCE TO RELATED APPLICATION(S)

The present disclosure relates to the subject matters contained in Japanese Patent Application No. 2008-086899 filed on Mar. 28, 2008, which are incorporated herein by reference in its entirety.

### FIELD

The present invention relates to an information receiver and a method for receiving information over a network from a various apparatuses which use Internet protocols of different versions as communication protocols.

### BACKGROUND

In a video distribution system in which service providers provide VOD (video on demand) or IP (Internet protocol) broadcasts, the Internet protocol is used for exchange of a stream or an information file. However, the Internet protocol used on the network depends on the service provider; for example, different Internet protocols such as IPv4 and IPv6 are used by service providers. In view of this, JP-A-2006-067613, for example, discloses an IPv4-IPv6 converting apparatus which is equipped with an IP transmitting/receiving module for transmitting and receiving IPv4 packets and IPv6 packets, an IP header converting module for performing conversion between IPv4 packets and IPv6 packets by IP header conversion, a DNS proxy module for accepting a domain information acquisition request sent from an IPv4 terminal or an IPv6 terminal and processing the request on behalf of a DNS server, an IPv4 address acquiring module for acquiring an IPv4 address from a DHCP server, and an IP address conversion information retaining module for retaining an IPv6 address of an IPv6 terminal and the IPv4 address acquired by the IPv4 address acquiring module in such a manner that they are correlated with each other, whereby the IPv6 terminal can communicate with the IPv4 terminal even if the former is not assigned an IPv4 address in advance in a fixed manner.

Incidentally, to allow a receiver apparatus that is compatible with plural service providers to receive a service, it is necessary for the receiver apparatus to connect to a server of a service provider concerned. Usually, a connection destination is expressed in a form called a URI (uniform resource identifier) or an FQDN (fully qualified domain name) instead of being designated directly by an IP address. Therefore, the receiver apparatus cannot determine whether an Internet protocol used by the server is IPv4 or the IPv6.

The receiver apparatus attempts to acquire an address of the server with an assumption that both IP addresses are correctly set. Therefore, in many cases, first the receiver apparatus inquires of an IPv6 DNS (domain name system) server and, if it fails, inquires of an IPv4 DNS server (name resolution by DNS) However, where the server is of IPv4, the receiver apparatus acquires a server address after inquiring of the IPv6 DNS server. As a result, if a request packet is lost or the IPv6 DNS server is in trouble, the time is consumed in connection processing that is irrelevant to a desired service. If server IP addresses are stored to avoid this problem, the advantages of using URIs or FQDNs are lost, that is, it becomes impossible to cope with a system change of a service provider or load distribution of a server.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 shows a configuration of a video distribution system according to an embodiment of the invention.

FIG. 2 is a block diagram showing a configuration of a receiver apparatus according to the embodiment.

FIG. 3 is a block diagram showing a configuration of another receiver apparatus according to the embodiment.

FIG. 4 shows an example set of records of server names and IP versions according to the embodiment.

FIG. 5 is a flowchart of a general DNS name resolution process.

FIG. 6 is a flowchart of a name resolution process that is performed when an IP version IPv6 is stored so as to be correlated with a server name concerned.

FIG. 7 is a flowchart of a name resolution process that is performed when an IP version IPv4 is stored so as to be correlated with the server name concerned.

### DETAILED DESCRIPTION OF THE EMBODIMENTS

An information receiver apparatus and a method for receiving information according to an embodiment of the present invention will be hereinafter described with reference to the accompanying drawings.

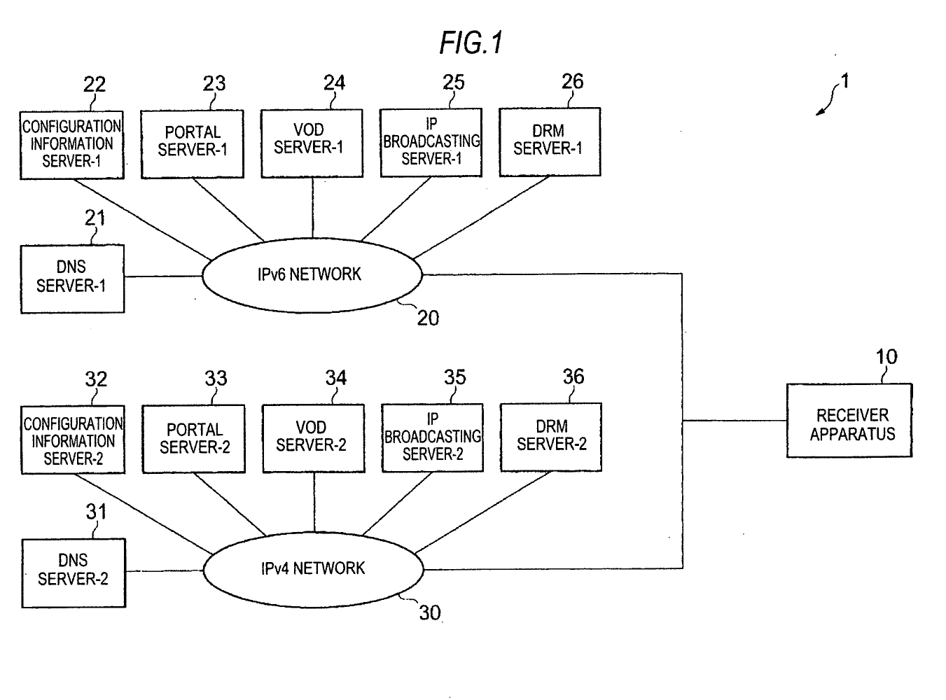

FIG. 1 shows a configuration of a video distribution system 1 according to the embodiment. As shown in FIG. 1, a receiver apparatus (information receiver apparatus) 10 such as an IPTV (Internet protocol television) apparatus or a personal computer can connect to an IPv6 network 20 and an IPv4 network 30. A DNS server 21, a configuration information server 22, a portal server 23, a VOD server 24, an IP broadcasting server 25, and a DRM server 26 are connected to the IPv6 network 20. A DNS server 31, a configuration information server 32, a portal server 33, a VOD server 34, an IP broadcasting server 35, and a DRM server 36 are connected to the IPv4 network 30. The system configuration, the server names, etc., shown in FIG. 1 are merely shown as an example, and the invention is not limited to those shown in the drawings and described below.

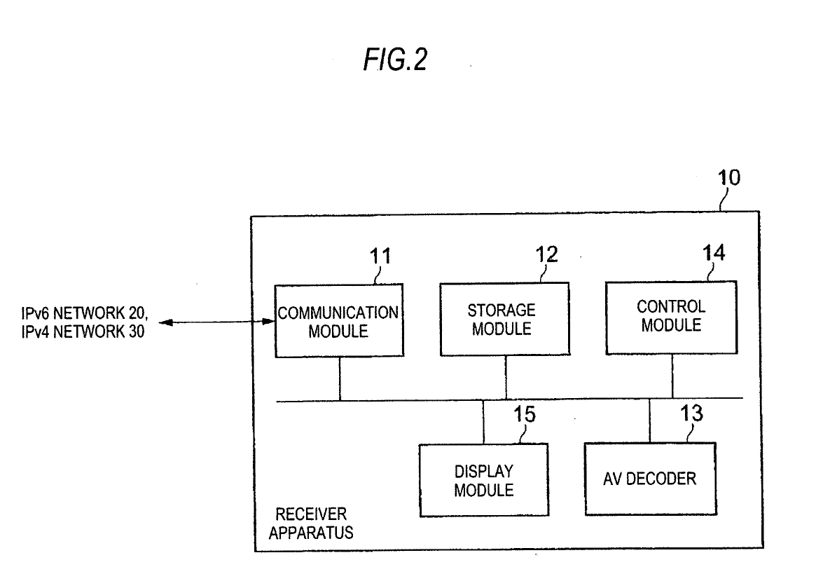

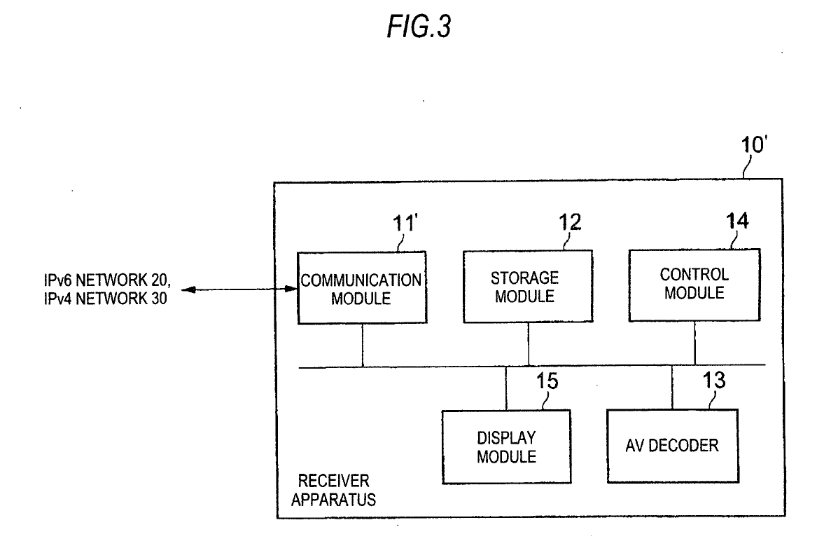

FIG. 2 is a block diagram showing the configuration of a receiver apparatus 10 according to the embodiment. As shown in FIG. 2, the receiver apparatus 10 according to the embodiment is equipped with a communication module (communication module) 11, a storage module (storage module) 12, an AV decoder 13, a control module 14, and a display module 15. The communication module 11 is to receive such information as video by connecting to the IPv6 network 20 which uses IPv6 (Internet protocol of a first version) as a communication protocol and the IPv4 network 30 which uses IPv4 (Internet protocol of a second version) as a communication protocol by means of a single interface (dual stack). FIG. 3 shows an alternative receiver apparatus 10′ in which a communication module 11′ has interfaces that are dedicated to the IPv6 network 20 and the IPv4 network 30, respectively.

The storage module 12 is to store names of servers on the IPv6 network 20 and the IPv4 network 30 from which the communication module 11 has received information in such a manner that they are correlated with the Internet protocol IPv6 or IPv4 used for those communications with the servers.

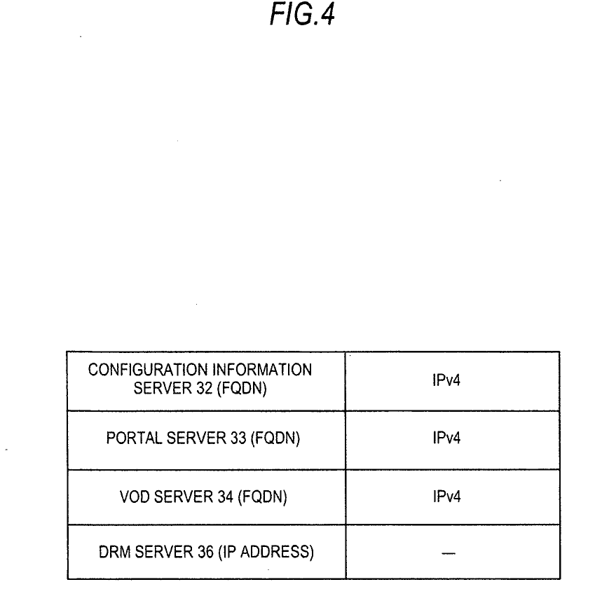

FIG. 4 shows an example set of records of server names and IP versions according to the embodiment. As shown in FIG. 4, when the communication module 11 has connected to the configuration information server 32, the portal server 33, and the VOD server 34 using FQDNs and acquired respective IP addresses by name resolution, the corresponding IP version IPv4 is stored so as to be correlated with each server name (FQDN). In the example of FIG. 4, name resolution was not necessary when the communication module 11 connected to the DRM server 36 using its IP address (direct connection). Therefore, no IP version is stored in the storage module 12 so as to be correlated with the DRM server 36. A server name and an IP version need not always be stored in the storage module 12 for every server to which the communication module 11 connected; a server name and an IP version may be stored only for servers to each of which a user will make connection plural times to receive a service or servers from which the receiver apparatus 10 will acquire information on a regular basis.

Returning to FIG. 2, the AV decoder 13 is to decode a video signal and an audio signal received by the communication module 11. The control module 14 is to control operations of the communication module 11, the storage module 12, the AV decoder 13, and the display module 15. The display module 15, which specifically consists of a liquid crystal display, a speaker, etc., is to output video and audio on the basis of a video signal and an audio signal decoded by the AV decoder 13.

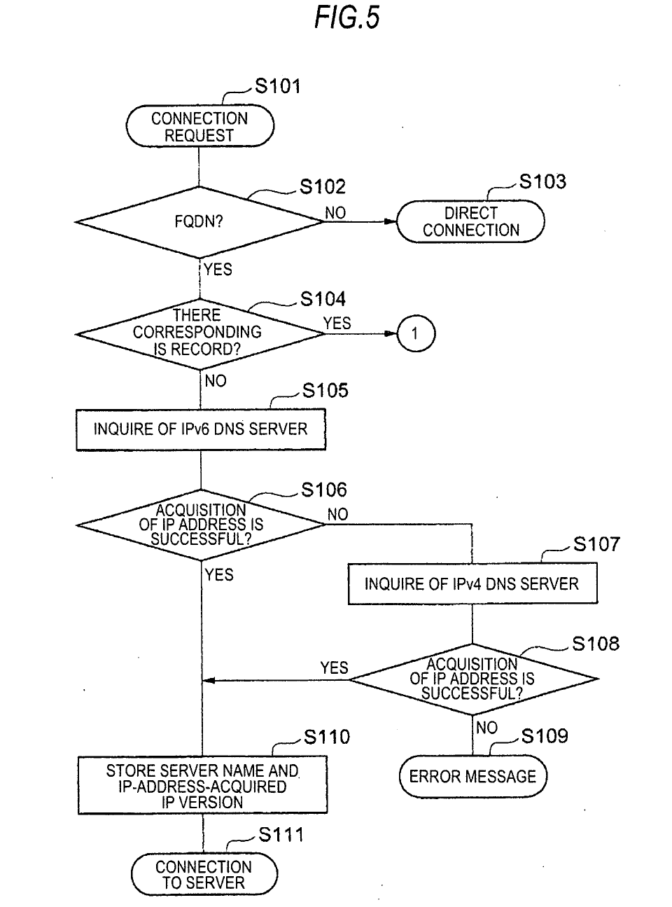

The operation of the receiver apparatus 10 according to the embodiment will be described below. FIG. 5 is a flowchart of a general DNS name resolution process. As shown in FIG. 5, also in the receiver apparatus 10 according to the embodiment, general DNS name resolution is performed when connection is made to each of the servers on the IPv6 network 20 and the IPv4 network 30 for the first time. An example that connection is made to the portal server 23 or 33 will be described below.

When a request for connection to the portal server 23 or 33 is made at step S101, if the server 23 or 33 is designated by an FQDN (S102: yes), the communication module 11 moves to step S104. If the server 23 or 33 is designated by an IP address (S102: no), at step S103 the communication module 11 establishes a connection using the IP address (direct connection).

If no record corresponding to the FQDN is stored in the storage module 12 (S104: no), at step S105 the communication module 11 inquires of the DNS server 21 in the IPv6network 20 about an IP address using the server name (FQDN). If failing to acquire an IP address of the server 23 or 33 (S106: no), at step S107 the communication module 11 inquires of the DNS server 31 in the IPv4 network 30 about an IP address.

If the communication module 11 fails to acquire an IP address from both of the DNS server 21 in the IPv6 network 20 and the DNS server 31 in the IPv4 network 30 (S108: no), at step S109 an error message is displayed on the display module 15. On the other hand, if the communication module 11 succeeds in acquiring an IP address of the portal server 23 or 33 from the DNS server 21 in the IPv6 network 20 or the DNS server 31 in the IPv4 network 30 (S106: yes or S108: yes), at step S110 the storage module 12 stores the server name and the IP-address-acquired IP version in such a manner that they are correlated with each other.

Although in the example of FIG. 5 the DNS name resolution is performed in the IPv6-to-IPv4 order, it may be performed in the IPv4-to-IPv6 order. Another modification is as follow. Name resolution is performed first with IPv4 if the IP version of one of servers to which the communication module 11 has connected so far is IPv4, and name resolution is performed first with IPv6 if the IP version of one of servers to which the communication module 11 has connected so far is IPv6.

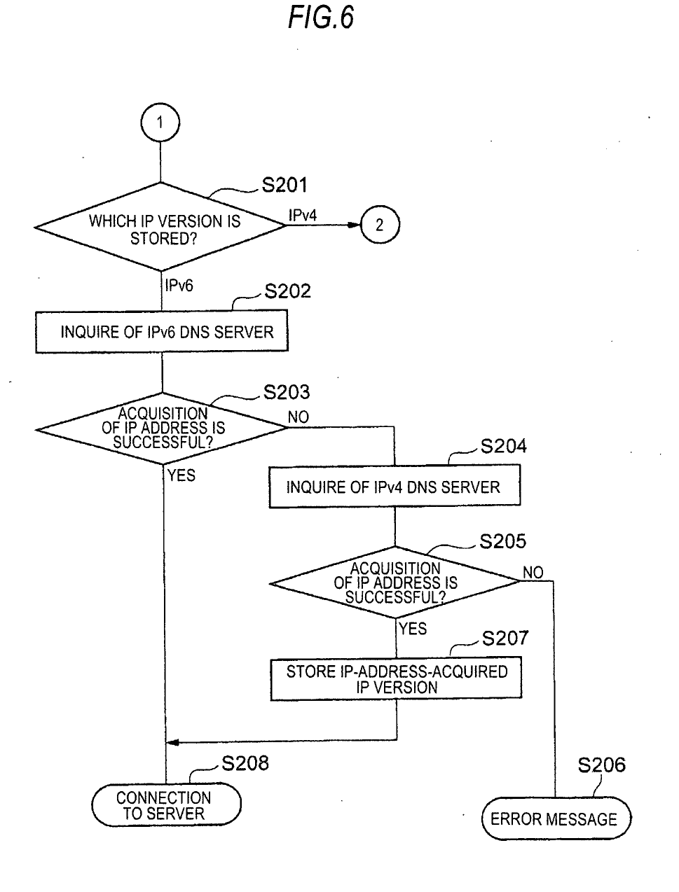

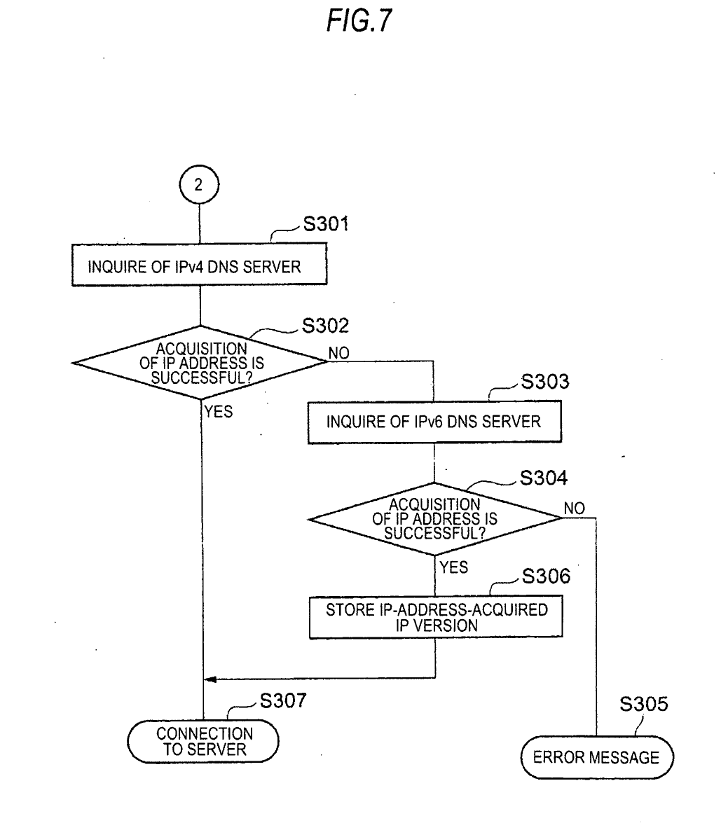

FIGS. 6 and 7 are flowcharts showing name resolution processes that are performed when the IP version IPv6 (FIG. 6) or IPv4 (FIG. 7) is stored in the storage module 12 so as to be correlated with the server name. As shown in FIG. 6, if determined at step S201 that the IP version IPv6 is stored in the storage module 12 so as to be correlated with the server name, at step S202 the communication module 11 inquires of the DNS server 21 in the IPv6 network 20 about an IP address using the server name. If succeeding in acquiring an IP address of the portal server 23 from the DNS server 21 in the IPv6 network 20, at step S208 the communication module 11 establishes a connection with the portal server 23 using the acquired IP address.

If failing to acquire an IP address of the server 23 from the DNS server 21 in the IPv6 network 20 (S203: no), at step S204 the communication module 11 inquires of the DNS server 31 in the IPv4 network 30 about an IP address.

If the communication module 11 fails to acquire an IP address from both of the DNS server 21 in the IPv6 network 20 and the DNS server 31 in the IPv4 network 30 (S205: no), at step S206 an error message is displayed on the display module 15. On the other hand, if the communication module 11 succeeds in acquiring an IP address of the portal server 33 from the DNS server 31 in the IPv4 network 30 (S205: yes), at step S207 the storage module 12 stores the server name again so as to be correlated with the IP-address-acquired IP version IPv4. At step S208, the communication module 11 establishes a connection with the portal server 33 using the acquired IP address.

On the other hand, as shown in FIGS. 6 and 7, if determined at step S201 that the IP version IPv4 is stored in the storage module 12 so as to be correlated with the server name, at step S301 the communication module 11 inquires of the DNS server 31 in the IPv4 network 30 about an IP address using the server name. If succeeding in acquiring an IP address of the portal server 33 from the DNS server 31 in the IPv6 network 30 (S302: yes), at step S307 the communication module 11 establishes a connection with the portal server 33 using the acquired IP address.

If failing to acquire an IP address of the server 33 from the DNS server 31 in the IPv4 network 30 (S302: no), at step S303 the communication module 11 inquires of the DNS server 21 in the IPv6 network 20 about an IP address.

If the communication module 11 fails to acquire an IP address from both of the DNS server 21 in the IPv6 network 20 and the DNS server 31 in the IPv4 network 30 (S304: no), at step S305 an error message is displayed on the display module 15. On the other hand, if the communication module 11 succeeds in acquiring an IP address of the portal server 23 from the DNS server 21 in the IPv6 network 20 (S304: yes), at step S306 the storage module 12 stores the server name again so as to be correlated with the IP-address-acquired IP version IPv6. At step S307, the communication module 11 establishes a connection with the portal server 23 using the acquired IP address.

In video distribution systems, there may occur a case that a configuration information file describing the configuration of a service concerned can be acquired from the configuration information server 22 or 32. In many cases, such a configuration information file contains multicast addresses for IP broadcast or information of other servers. Therefore, the communication module 11 may be such as to change the priority between IPv6 and IPv4 on the basis of such multicast address values or information containing other direct IP addresses.

According to the embodiment, from a second communication onward, the communication module 11 performs name resolution with the DNS servers 21 and 31 using an IP version that is stored in the storage module 12 so as to be correlated with a server name (FQDN). Therefore, the embodiment makes it possible to increase the speed of connection to apparatus that use Internet protocols of different versions as communication protocols without losing the advantages of using URIs or FQDNs, as well as to increase the ease of operation of a user.

In particular, the embodiment may be modified so that name resolution is performed first with IPv4 if the IP version of one of servers to which the communication module 11 has connected so far is IPv4 and name resolution is performed first with IPv6 if the IP version of one of servers to which the communication module 11 has connected so far is IPv6. This increases the probability that the speed of connection is increased.

In addition, the embodiment may be modified so that the priority between IPv6 and IPv4 is changed on the basis of such multicast address values contained in a configuration information file that is stored in the configuration information server 22 or 32. This also contributes to increasing the speed of connection.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information receiver comprising:
a communication module that is configured to receive, over a network, information from a first apparatus that uses an internet protocol of a first version as a communication protocol and a second apparatus that uses an internet protocol of a second version as a communication protocol; and
a storage module that stores names of the first apparatus and the second apparatus from which the communication module has received information, each of the names being correlated with the internet protocol of one of the first version and the second version being used when the respective names are received,
wherein the communication module receives information from the first apparatus or the second apparatus using the internet protocol of the first version or second version by referring to the names and the internet protocol being correlated therewith stored in the storage module.

2. The receiver according to claim 1, wherein the communication module receives information from the first apparatus or the second apparatus using the internet protocol of the first version or the second version that was used in preceding reception of information from the first apparatus or the second apparatus.

3. The receiver according to claim 1, wherein the communication module receives information using the Internet protocol of the first version or the second version according to multicast addresses contained in network configuration information stored in a configuration information server that is connected to the network.

4. The receiver according to claim 1, wherein the communication module receives information from the first apparatus or the second apparatus by acquiring an IP address of the first apparatus or the second apparatus from a DNS server corresponding to the internet protocol of the first version or the second version that is stored by the storage module so as to be correlated with the name of the first apparatus or the second apparatus.

5. The receiver according to claim 1 further comprising a display module that displays the information received by the communication module.

6. A method for receiving information, the method comprising:
receiving, over a network, information from a first apparatus that uses an internet protocol of a first version as a communication protocol and a second apparatus that uses an internet protocol of a second version as a communication protocol;
storing names of the first apparatus and the second apparatus from which the communication module has received information, each of the names being correlated with the internet protocol of one of the first version and the second version being used when the respective names are received; and
receiving information from the first apparatus or the second apparatus using the internet protocol of the first version or second version by referring to the stored names and the stored internet protocol being correlated therewith.

7. The method according to claim 6, wherein the information is received from the first apparatus or the second apparatus using the internet protocol of the first version or the second version that was used in preceding reception of information from the first apparatus or the second apparatus.

8. The method according to claim 6, wherein the information is received using the internet protocol of the first version or the second version according to multicast addresses contained in network configuration information stored in a configuration information server that is connected to the network.

9. The method according to claim 6, wherein the information is received from the first apparatus or the second apparatus by acquiring an IP address of the first apparatus or the second apparatus from a DNS server corresponding to the internet protocol of the first version or the second version that is stored so as to be correlated with the name of the first apparatus or the second apparatus.
